(19) United States
(12) Patent Application Publication
(10) Pub. No.: US 2023/0325129 A1
(43) Pub. Date: Oct. 12, 2023

(54) PRINT MATERIAL SUPPLY SELECTIONS

(71) Applicant: Hewlett-Packard Development Company, L.P., Spring, TX (US)

(72) Inventors: Sean Daniel FitzGerald, Boise, ID (US); Gabriel Scott McDaniel, Boise, ID (US); Jeffrey H. Luke, Boise, ID (US)

(21) Appl. No.: 18/023,374

(22) PCT Filed: Oct. 1, 2020
(86) PCT No.: PCT/US2020/053772

§ 371 Date: Feb. 26, 2023

(51) Int. Cl. G06F 3/12; G06Q 10/083

(52) U.S. Cl. CPC G06F 3/121; G06F 3/1229; G06Q 10/083

(57) ABSTRACT

In some examples, a computing device can include a processing resource and a memory resource storing instructions to cause the processing resource to determine, based on a geographic identifier of an imaging device, environmental information for a location associated with the imaging device, determine operational information for the imaging device, and select, based on at least one of the environmental information and the operational information, a print material supply for the imaging device.

### BACKGROUND

Imaging devices, such as printers, copiers, etc., may be used to form markings on a physical medium, such as text, images, etc. In some examples, imaging devices may form markings on the physical medium by performing a print job. A print job can include forming markings such as text and/or images by transferring a print material (e.g., ink, toner, etc.) to a physical medium.

### BRIEF DESCRIPTION OF THE DRAWINGS

FIG. 1 is an example of a system for print material supply selections consistent with the disclosure.

FIG. 2 is an example of a computing device for print material supply selections consistent with the disclosure.

FIG. 3 is a block diagram of an example system for print material supply selections consistent with the disclosure.

FIG. 4 is an example of a method for print material supply selections consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images models, etc.) on the medium during a print job. Print material may include ink, toner, polymers, metals, colorants, etc.

The print material can be deposited onto a physical medium. As used herein, the term “imaging device” refers to any hardware imaging device with functionalities to physically produce representation(s) (e.g., text, images, models, etc.) on the medium. In some examples, a “medium” may include paper, photopolymers, plastics, composite, metal, wood, fabric, or the like. An imaging device can be a printing device (e.g., a printer). An imaging device can include printing (e.g., two-dimensional printing and/or three-dimensional printing capabilities), scanning, faxing, and/or other imaging device functionalities, and can perform print jobs when in receipt of a print job request from a computing device or other network (e.g., Internet) connected device.

A device, such as a computing device, can generate data, machine code, or instructions such as a print job request and transmit the print job request to an imaging device. The imaging device can perform the print job according to the received print job request.

An imaging device can perform the print job by depositing print material onto a print medium from a print material supply or other print medium reloading device. As used herein, the term “print material supply” refers to a vessel including print material. For example, the print material supply can include print material that can be deposited onto a print medium to form text and/or images on the print medium during a print job.

When an amount of print material remaining in a print material supply is low, a supplier may supply another print material supply prior to the print material supply running out of print material. Such print material supplies may be shipped to the user from the supplier. For instance, in some examples a user may utilize a subscription service so that when the print material supply is low on print material, the replacement print material supply can be supplied to the user by the supplier just prior to the current print material supply running out of print material.

An imaging device may be designed to accommodate a first print material supply size. However, in some instances, print material supplies may be designed larger than the first print material supply size (while still fitting within the imaging device) in order to maximize an amount of print jobs the imaging device can perform.

However, such larger print material supplies may restrict air flow through the imaging device relative to the smaller first print material supply sizes and/or may lead to additional heat generation due to less free-space in the imaging device as a result of the larger print material supplies. Restricted air flow can cause internal temperatures within the imaging device to rise above a threshold temperature, especially for print jobs having high page counts, which can lead to issues such as print job defects, overheating of the imaging device (e.g., overheating of electrical components or otherwise), clumping and/or melting of print material in the print material supply, etc.

Additionally, some imaging devices may include an operating mode to rectify overheating in the imaging device. For example, if restricted air flow or otherwise leads to internal temperatures within the imaging device rising above a threshold temperature, the imaging device can slow down print speeds, pause between print jobs and/or print head passes, etc. in order to reduce the internal temperature of the imaging device. However, a user become frustrated or otherwise have a bad experience with the imaging device as such operating modes occur. Further, the operating mode to rectify overheating in the imaging device may not be effective in certain environments in which an ambient temperature around the imaging device is too high (e.g., in a non-air-conditioned space in summer time, for instance).

Print material supply selections according to the disclosure can allow for automatic selection of an appropriately sized print material supply for an imaging device to prevent internal temperatures rising above a threshold level in the imaging device. Such selection of a print material supply can prevent air flow restrictions so that operating modes to rectify overheating can be avoided. Accordingly, a user can utilize the imaging device for print jobs without temperature delays, avoiding a negative experience for a user.

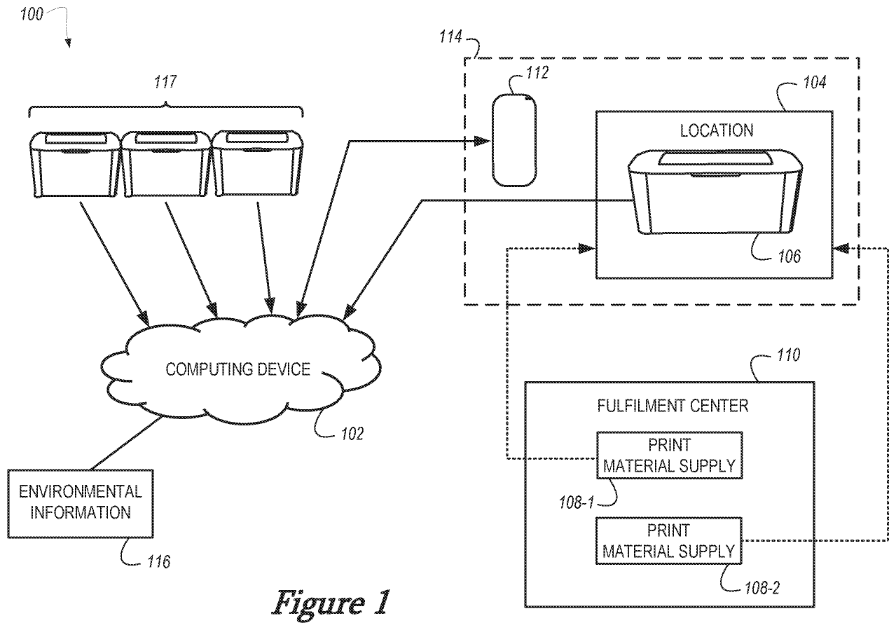

FIG. 1 is an example of a system for print material supply selections consistent with the disclosure. The system 100 can include a computing device 102, a location 104, an imaging device 106, print material supplies 108-1, 108-2, a fulfillment center 110, a mobile device 112, risk area 114, and environmental information 116.

As is further described herein, the computing device 102 can utilize environmental information 116 to facilitate selection and delivery of a print material supply 108-1, 108-2 to the location 104. In order to begin the delivery of the print material supply 108, the computing device 102 can receive a fulfillment signal from the imaging device 106 via a wired or wireless connection, as is further described herein. As used herein, the term “fulfillment signal” refers to a transmission that includes information detailing a state of a print material supply included in an imaging device. For example, the fulfillment signal can indicate to the computing device 102 that based on previous print jobs and an amount of print material remaining in the print material supply included in the imaging device 106 (e.g., not illustrated in FIG. 1), the computing device 102 can select a print material supply 108-1, 108-2 for shipment to the location 104 as is further described herein. The print material supply 108 can be shipped to the location 104 in order to be installed in the imaging device 106 to allow the imaging device 106 to continue to perform print jobs.

Although computing device 102 is described above as selecting the print material supply 108-1, 108-2 for shipment to the location 104, examples of the disclosure are not so limited. For example, another computing device (e.g., not illustrated in FIG. 1) may be connected to the computing device 102 (e.g., via a network relationship) and can select the print material supply 108-1, 108-2 for shipment to the location 104.

As used herein, the term “computing device” refers to an electronic system having a processing resource, memory resource, and/or an application-specific integrated circuit (ASIC) that can process data and/or information. Examples of computing devices can include, for instance, a laptop computer, a notebook computer, a desktop computer, a server, networking equipment (e.g., router, switch, etc.), and/or a mobile device, among other types of computing devices. As used herein, the term “mobile device” can include devices that are (or can be) carried and/or worn by the user. For example, mobile device 112 can be a phone (e.g., a smart phone), a tablet, a personal digital assistant (PDA), smart glasses, and/or a wrist-worn device (e.g., a smart watch), among other types of mobile devices.

In order to facilitate the computing device 102 selecting a print material supply 108-1, 108-2, the computing device 102 can determine environmental information for a location 104 associated with the imaging device 106, as is further described herein. The computing device 102 can determine the environmental information based on a geographic identifier. As used herein, the term “geographic identifier” refers to data that describes a location. For example, the geographic identifier can include a physical location address corresponding to the imaging device 106, zone improvement plan (ZIP) code corresponding to the imaging device 106 and/or a geographic location of a mobile device 112 associated with the imaging device 106, among other examples, as is further described herein.

Although computing device 102 is described above as determining environmental information for the location 104, examples of the disclosure are not so limited. For example, another computing device (e.g., not illustrated in FIG. 1) may be connected to the computing device 102 (e.g., via a network relationship) and can determine environmental information for the location 104.

The geographic identifier can include an address corresponding to the imaging device 106. As used herein, the term “address” refers to a collection of information used to designate a location. For example, the location 104 can be associated with the imaging device 106 and include an address that can include a number corresponding to a structure of the location 104, a street name located proximate to the location 104, and/or a ZIP code for the location 104.

In some examples, the geographic identifier can include a ZIP code corresponding to the imaging device 106. As used herein, the term “ZIP code” refers to a postal code used to designate a location. For example, a ZIP code can be 85001 to designate a location corresponding to Phoenix, Arizona.

The geographic identifier can include a geographic location of a mobile device 112 associated with the imaging device 106. For example, the mobile device 112 can be associated with the imaging device 106 and can generate a geolocation for the imaging device 106 based on the location of the mobile device 112 when the mobile device 112 is located proximate to the imaging device 106. For example, the mobile device 112 can utilize geolocation mechanisms (e.g., global positioning system (GPS), Wi-Fi, Internet Protocol (IP) address, cellular device tower, Point of Presence, etc.) to determine a location of the mobile device 112 when located proximate to the imaging device 106 to determine a location of the imaging device 106.

Although the geographic identifiers are described above as including an address corresponding to the imaging device 106/location 104 and/or a geographic location of the mobile device 112 associated with the imaging device 106, examples of the disclosure are not so limited. In some examples, the location information can be determined based on an IP address of the imaging device 106. In some examples, the location information associated with the location 104 can include geolocation mechanisms (e.g., global positioning system (GPS), Wi-Fi, IP address, Point of Presence, etc.) to determine a location of the imaging device 106 which can correspond to the location information for the location 104.

As described above, the computing device 102 can determine environmental information for a location 104 associated with the imaging device 106 based on the geographic identifier of the imaging device 106. As used herein, the term “environmental information” refers to data describing environmental conditions in a location. The computing device 102 can determine environmental information for the location 104 utilizing environmental information 116. Environmental information 116 can include information gathered and provided by a weather data service to the computing device 102 for different locations where a print material supply may be shipped. The environmental information 116 can include future environmental information, historical environmental information, current environmental conditions, etc. As used herein, the term “future environmental information” refers to environmental information for a time in the future. For example, the computing device 102 can determine the future temperature for the location 104 (e.g., 95′ Fahrenheit (F)) for a predicted time period, historical temperature information (e.g., 90° F. average the previous year), current temperature conditions (e.g., 87° F. on September 3^{rd}) etc. Additionally, as used herein, the term “historical environmental information” refers to environmental information for a time in the past. Further, as used herein, the term “current environmental information” refers to environmental information for the present time. As the location 104 may not include climate-controls such as air-conditioning (e.g., a warehouse without climate controls), the computing device 102 can determine the future temperature for the location 104 to be the outside air temperature (e.g., 95° F.), as assuming the location 104 may include climate controls (e.g., and as such a lower future temperature for the location 104) could lead to selection of a print material supply 108-1, 108-2 that can lead to restricted air flow in the imaging device 106 and as a result, temperatures within the imaging device 104 that can lead to print job defects, overheating of the imaging device, clumping and/or melting of print material in the print material supply, etc.

Although the environmental information is described above as being temperature information, examples of the disclosure are not so limited. For example, the environmental information 116 can include temperature, barometric pressure, humidity, wind conditions, dust conditions, pollen counts, ultraviolet (UV) index, dew points, cloud cover, etc. Accordingly, the computing device 102 can determine future wind speeds for the location 104 (e.g., 15 miles per hour (mph) for a predicted time period) and historical wind speeds for the location 104 (e.g., 10 mph average the previous year), future dust concentrations for the location 104 and/or dust concentrations for the previous year, etc.

The computing device 102 can determine operational information for the imaging device 106. As used herein, the term “operational information” refers to data describing functional processes of an imaging device. For example, operational information can include usage information, error information (e.g., support tickets, printing errors (e.g., print job related, thermal related, etc.)), as are further described herein.

The operational information for the imaging device 106 can include usage information. As used herein, the term “usage information” refers to data describing activity performed by an imaging device. For example, the usage information of imaging device 106 can include number of pages printed, number of print jobs performed, types of print jobs performed (e.g., letter sized print jobs, envelope print jobs, etc.) in real time, historical number of pages printed in a predefined time period (e.g., a day) over a predefined time period (e.g., weeks, months, years, etc.) so that such historical pages printed (e.g., pages printed in a day over a week, a month, a year, etc.) can indicate potential for future predictions in spikes in usage/printing page volume based on consistent trends in historical usage, imaging device diagnostic information (e.g., internal imaging device temperatures, etc.), among other types of usage information.

The operational information for the imaging device 106 can include error information. As used herein, the term “error information” refers to data describing a deviation from a predetermined condition. For example, error information can include imaging device 106 overheating errors, misfeed errors, print material supply errors (e.g., print material included in the print material supply is low, is clumped, is solid, etc.), among other error information.

Utilizing the environmental information and/or the operational information, the computing device 102 can select a print material supply 108-1, 108-2 for the imaging device 106. That is, based on environmental information (e.g., an environmental condition such as temperature, barometric pressure, humidity, wind conditions, dust conditions, pollen counts, ultraviolet (UV) index, dew points, cloud cover, etc.) exceeding a threshold value, the computing device 102 can select either print material supply 108-1 or 108-2, as is further described herein. Additionally and/or alternatively, based on operational information (e.g., number of print jobs performed, types of print jobs performed, etc.) exceeding a threshold value, the computing device 102 can select either print material supply 108-1 or 108-2, as is further described herein.

As illustrated in FIG. 1, the system 100 can include a fulfilment center 110. As used herein, the term “fulfilment center” refers to a location where print material supplies can be stored, packaged, and/or shipped from, among other examples. The fulfilment center 110 can include the print material supply 108-1 and print material supply 108-2. The print material supplies 108-1 and 108-2 can be differently sized. For example, print material supply 108-1 can be physically smaller than the print material supply 108-2. Accordingly, the print material supply 108-1 can include less print material than the print material supply 108-2. In other words, the print material supply 108-1 can be physically smaller than the print material supply 108-2 and as such, may include less print material than the print material supply 108-2, and the print material supply 108-2 can be physically larger than the print material supply 108-1 and as such, may include more print material than the print material supply 108-1 and more life expectancy than the print material supply 108-1.

While the print material supply 108-2 is described above as being physically larger than print material supply 108-1, examples of the disclosure are not so limited. For example, the print material supply 108-1 and 108-2 may include a same volume of print material but print material supply 108-2 may be shaped in such a way as to restrict airflow and/or cause heat convective current flow reduction through the imaging device 106 to cause print job defects, overheating of the imaging device (e.g., overheating of electrical components or otherwise), clumping and/or melting of print material in the print material supply, etc.

As described above, certain sized print material supplies can cause air flow restrictions and/or heat convective current flow reduction in the imaging device 106, which may result in an internal temperature of the imaging device 106 rising above a threshold temperature. Such an overheating of the imaging device 106 can cause print job errors, operation of the imaging device 106 in overheating operating modes, etc. In order to prevent such instances, the computing device 102 can select the smaller print material supply 108-1 for shipment to the location 104 in certain circumstances (e.g., based on the environmental information at the location 104 and/or operational information for the imaging device 106), as is further described herein.

The computing device can select the first print material supply 108-1 in response to the environmental information exceeding a threshold value and/or the operational information exceeding a different threshold value. For example, the environmental information can be a future temperature for a predicted time period (e.g., 95° average at the location 104) exceeding a threshold temperature (e.g., 85°) and an amount of pages printed (e.g., 3,000 pages) within a time period (e.g., one month). Based on the future temperature exceeding a threshold temperature and the amount of pages printed within the time period, the computing device can select the first print material supply 108-1 in order to avoid air flow restrictions in the imaging device 106 to prevent the imaging device 106 from overheating.

The computing device 102 can select the second print material supply 108-2 in response to the environmental information not exceeding a threshold and/or the operational information not exceeding a different threshold value. For example, the environmental information can be a future temperature for a predicted time period (e.g., 80° average at the location 104) not exceeding a threshold temperature (e.g., 85°) and an amount of pages printed (e.g., 1,000 pages) within a time period (e.g., one month). Based on the future temperatures not exceeding the threshold temperature and/or the amount of pages printed within the time period, the computing device can select the second (e.g., larger) print material supply 108-2, as air flow restrictions and imaging device 106 overheating is not a concern.

As another example, the computing device 102 can select the first print material supply 108-1 in response to operational information exceeding a threshold value. For example, the environmental information can be a future temperature for a predicted time period (e.g., 80° average at the location 104) not exceeding a threshold temperature (e.g., 85°), print type (e.g., letters) and an amount of pages printed (e.g., 2,000 pages) within a time period (e.g., one month), and/or historical trending over time for the same time period. While the future temperature is not predicted to exceed a threshold temperature, the print type (e.g., letter) may generate additional heat relative to printing legal-size pages. Accordingly, the computing device 102 can select the first (e.g., smaller) print material supply 108-1, as the type of print job the imaging device 106 has typically performed may implicate temperature considerations and the smaller print material supply 108-1 can better serve to prevent the imaging device 106 from overheating.

As another example, the computing device 102 can select the first print material supply 108-1 in response to environmental information exceeding a threshold value. For example, the environmental information can be future dust amounts for a predicted time period exceeding a threshold value. Accordingly, the computing device 102 can select the first (e.g., smaller) print material supply 108-1, as the dust amounts may implicate temperature considerations and the smaller print material supply 108-1 can better serve to prevent the imaging device 106 from overheating.

As another example, the computing device 102 can select the first print material supply 108-1 in response to operational information exceeding a threshold value. For example, the operational information can include thermal related printing errors exceeding a threshold amount of thermal related printing errors. Accordingly, the computing device 102 can select the first (e.g., smaller) print material supply 108-1 in order to try to reduce the amount of thermal related printing errors by the smaller print material supply 108-1 can better serving to prevent the imaging device 106 from overheating.

Although the environmental information and operational information are described above as being temperature, dust, print types, thermal related errors, etc., examples of the disclosure are not so limited. For example, the computing device 102 can select the print material supply 108-1 or 108-2 based on any other past, current, or future environmental information (e.g., temperature, barometric pressure, humidity, wind conditions, dust conditions, pollen counts, ultraviolet (UV) index, dew points, cloud cover, etc.) and/or past, current, or future operational information (e.g., support tickets, printing errors (e.g., print job related, thermal related, etc.)).

The computing device 102 can cause the selected print material supply 108-1 or 108-2 to be shipped to the location 104. For example, the computing device 102 can cause the shipping service to transport the selected print material supply 108-1 or 108-2 from the fulfilment center 110 to the location 104. Accordingly, print material supply selections can automatically select an appropriately sized print material supply for the imaging device 106 so as to avoid overheating of the imaging device 106.

In some examples, the print material supply 108-1 or 108-2 can further be selected based on imaging device fleet information. That is, the computing device 102 can select the print material supply 108-1 or 108-2 based on imaging device fleet information and environmental information and/or operational information exceeding a threshold value, as is further described herein.

As illustrated in FIG. 1, the system 100 can include an imaging device fleet 117. As used herein, the term “imaging device fleet” refers to a collection of imaging devices that can be a same or similar imaging device as imaging device 106. As used herein, the term “imaging device fleet information” refers to information describing other imaging devices that may be of a same manufacturer, a same device model, a same manufacturer, a same manufacturing lot, same or similar usage conditions (e.g., environmental factors such as temperature, humidity, location, etc.), continuous image (contone) evaluation, a same print material supply model, a same print material supply manufacturing lot, component lot code, etc. For example, the computing device 102 can receive the imaging device fleet data from the fleet of imaging devices 117. The imaging device fleet data can include past operational information (e.g., support tickets, printing errors (e.g., print job related, thermal related, etc.)) for the fleet (e.g., the plurality of) imaging devices 117.

Utilizing machine learning, the computing device 102 can determine future operational information for the imaging device 106 and/or the fleet of imaging devices 117. For example, based on past support tickets, printing errors, and/or environmental information associated with the fleet of imaging devices 117, the computing device 102 can better predict the types of conditions imaging devices may face, which can aid in selection of an appropriate print material supply 108-1, 108-2, as described above.

In some examples, utilizing the future operational information and/or the operational information and/or the environmental information for the imaging device 106 and/or the fleet of imaging devices 117, the computing device 102 can determine risk areas. As used herein, the term “risk area” refers to a geographic area which may experience higher rates of environmental information and/or operational information exceeding threshold values relative to other areas. For example, the computing device 102 can determine, based on environmental information and operational information, that the imaging device 106 is located in a risk area 114. as is further described herein.

The computing device 102 can determine a risk area 114 by correlating imaging device fleet data to locations of the fleet of imaging devices 117, a time period, and environmental information for the locations of the fleet of imaging devices 117 for the time period. For example, the computing device 102 can determine that imaging device 106 (e.g., included in the fleet of imaging devices 117) experiences temperatures that routinely exceed a threshold temperature for time periods encompassing a calendar year. Accordingly, the computing device 102 can determine that imaging device 106 is within a risk area 114 and accordingly, the computing device 102 can select the smaller print material supply 108-1.

In some examples, the computing device 102 can determine that the imaging device 106 experiences temperatures that exceed a threshold temperature for a time period between the months of May through September, but experiences temperatures that do not exceed a threshold temperature for a time period between October through April. Accordingly, the computing device 102 can determine that the imaging device 106 is within a risk area for the time period of May through September and as such, if the imaging device 106 is to receive a print material supply in that time frame, the computing device 102 can select the smaller print material supply 108-1, and if the imaging device 106 is to receive a print material supply in the time frame of October through April (e.g., and the print material supply can be utilized within that time frame based on past usage information), the computing device 102 can select the larger print material supply 108-2.

In other words, the computing device 102 can determine whether the imaging device 106 (e.g., or any other imaging device included in the fleet of imaging devices 117) are included in a risk area (e.g., risk area 114). The computing device 102 can select a replacement print material supply 108-1, 108-2 for the imaging device 106 based on the imaging device 106 (e.g., or any other imaging device included in the fleet of imaging devices 117) being included in the risk area 114. That is, the computing device 102 can select the smaller replacement print material supply 108-1 in response to the location of the imaging device 106 being within the risk area 114 (e.g., or any other imaging device included in the fleet of imaging devices 117 being in a risk area), or the computing device 102 can select the larger replacement print material supply 108-2 in response to the location of the imaging device 106 not being within the risk area 114 (e.g., or any other imaging device included in the fleet of imaging devices 117 being outside a risk area).

Print material supply selections according to the disclosure can allow for automatic selection of a print material supply for an imaging device so as to avoid overheating of the imaging device. Such a selection can prevent air flow restrictions in order to avoid overheating the imaging device. Accordingly, the imaging device can avoid printing errors, printing job malfunctions, delays, etc. to provide a positive experience for the user.

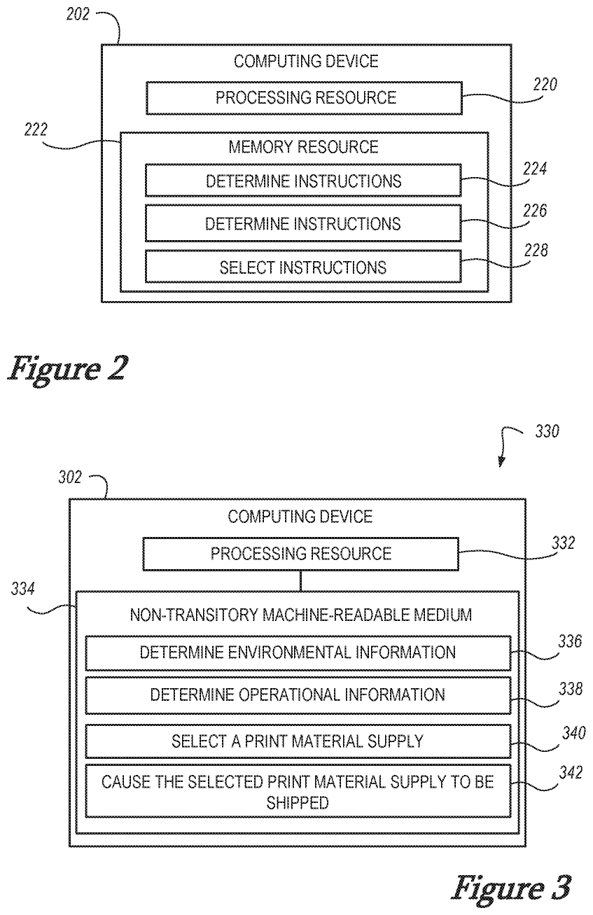

FIG. 2 is an example of a computing device 202 for print material supply selections consistent with the disclosure. As described herein, the computing device 202 may perform functions related to print material supply selections. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and across multiple processors. Put another way, the instructions executed by the computing device 202 may be stored across multiple machine-readable storage mediums and executed across multiple processors, such as in a distributed or virtual computing environment.

Processing resource 220 may be a central processing unit (CPU), a semiconductor-based microprocessor, and/or other hardware devices suitable for retrieval and execution of machine-readable instructions 224, 226, 228 stored in a memory resource 222. Processing resource 220 may fetch, decode, and execute instructions 224, 226, 228. As an alternative or in addition to retrieving and executing instructions 224, 226, 228, processing resource 220 may include a plurality of electronic circuits that include electronic components for performing the functionality of instructions 224, 226, 228.

Memory resource 222 may be any electronic, magnetic, optical, or other physical storage device that stores executable instructions 224, 226, 228, and/or data. Thus, memory resource 222 may be, for example, Random Access Memory (RAM), an Electrically-Erasable Programmable Read-Only Memory (EEPROM), a storage drive, an optical disc, and the like. Memory resource 222 may be disposed within computing device 202, as shown in FIG. 2. Additionally, memory resource 222 may be a portable, external or remote storage medium, for example, that causes computing device 202 to download the instructions 224, 226, 228 from the portable/external/remote storage medium.

The computing device 202 may include instructions 224 stored in the memory resource 222 and executable by the processing resource 220 to determine, based on a geographic identifier of an imaging device, environmental information for a location associated with the imaging device. The environmental information can include past, current, and/or future environmental information including temperature, barometric pressure, humidity, wind conditions, dust conditions, pollen counts, ultraviolet (UV) index, dew points, cloud cover, etc.

The computing device 202 may include instructions 226 stored in the memory resource 222 and executable by the processing resource 220 to determine operational information for the imaging device. The operational information can include usage information, error information (e.g., support tickets, printing errors (e.g., print job related, thermal related, etc.)), etc.

The computing device 202 may include instructions 228 stored in the memory resource 222 and executable by the processing resource 220 to select, based on at least one of the environmental information and the operational information, a print material supply for the imaging device. For example, the computing device 202 can select a first print material supply being a first size or a second print material supply being a second size, where the first size print material supply is physically smaller relative to the second size print material supply.

FIG. 3 is a block diagram of an example system 330 for print material supply selections consistent with the disclosure. In the example of FIG. 3, system 330 includes a computing device 302 including a processing resource 332 and a non-transitory machine-readable storage medium 334. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 332 may be a central processing unit (CPU), microprocessor, and/or other hardware device suitable for retrieval and execution of instructions stored in machine-readable storage medium 334. In the particular example shown in FIG. 3, processing resource 332 may receive, determine, and send instructions 336, 338, 340, 342. As an alternative or in addition to retrieving and executing instructions, processing resource 332 may include an electronic circuit comprising a number of electronic components for performing the operations of the instructions in machine-readable storage medium 334. With respect to the executable instruction representations or boxes described and shown herein, it should be understood that part or all of the executable instructions and/or electronic circuits included within one box may be included in a different box shown in the figures or in a different box not shown.

Machine-readable storage medium 334 may be any electronic, magnetic, optical, or other physical storage device that stores executable instructions. Thus, machine-readable storage medium 334 may be, for example, Random Access Memory (RAM), an Electrically-Erasable Programmable Read-Only Memory (EEPROM), a storage drive, an optical disc, and the like. The executable instructions may be “installed” on the system 330 illustrated in FIG. 3. Machine-readable storage medium 334 may be a portable, external or remote storage medium, for example, that allows the system 330 to download the instructions from the portable/external/remote storage medium. In this situation, the executable instructions may be part of an “installation package”.

Determine environmental information instructions 336, when executed by a processor such as processing resource 332, may cause system 330 to determine, based on a geographic identifier of an imaging device, environmental information for a location associated with the imaging device. The environmental information can include past, current, and/or future environmental information including temperature, barometric pressure, humidity, wind conditions, dust conditions, pollen counts, ultraviolet (UV) index, dew points, cloud cover, etc.

Determine operational information instructions 338, when executed by a processor such as processing resource 332, may cause system 330 to determine operational information for the imaging device. The operational information can include usage information, error information (e.g., support tickets, printing errors (e.g., print job related, thermal related, etc.)), etc.

Select a print material supply instructions 340, when executed by a processor such as processing resource 332, may cause system 330 to select, based on at least one of the environmental information and the operational information exceeding a threshold value, a print material supply for the imaging device. For example, the computing device 302 can select a first print material supply being a first size or a second print material supply being a second size, where the first size print material supply is physically smaller relative to the second size print material supply.

Cause the selected print material supply to be shipped instructions 342, when executed by a processor such as processing resource 332, may cause system 330 to cause the selected print material supply to be shipped to the location. For example, the print material supply can be shipped from a fulfilment center to the location including the imaging device.

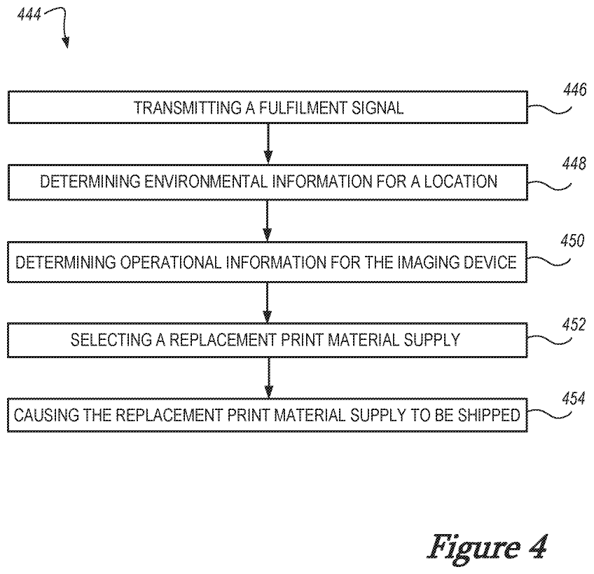

FIG. 4 is an example of a method 444 for print material supply selections consistent with the disclosure. The method 444 can be performed by a computing device (e.g., computing device 102, 202, and 302, previously described in connection with FIGS. 1, 2, and 3, respectively).

At 446, the method 444 includes transmitting, by an imaging device, a fulfilment signal to a computing device in response to an amount of print material in a print material supply being less than a threshold amount. In some examples, the amount of print material in the print material supply can be reported in terms of amount of print material remaining, amount of print material used, percentage of print material supply remaining and/or percentage of print material supply used, rotations, cycles, and/or age. For example, the amount of print material in the first print material supply may be running low and if not replaced, may begin to execute print jobs that form representations (e.g., text, images, models, etc.) on a print medium that may be faded relative to a new print material supply, To initiate a replacement process, the imaging device can transmit the fulfilment signal to the computing device.

At 448, the method 444 includes determining, by the computing device based on a geographic identifier of the imaging device, environmental information for a location associated with the imaging device in response to receiving the fulfilment signal. The environmental information can include past, current, and/or future environmental information including temperature, barometric pressure, humidity, wind conditions, dust conditions, pollen counts, ultraviolet (UV) index, dew points, cloud cover, etc.

At 450, the method 444 includes determining, by the computing device, operational information for the imaging device. The operational information can include usage information, error information (e.g., support tickets, printing errors (e.g., print job related, thermal related, etc.)), etc.

At 452, the method 444 includes selecting, by the computing device based on imaging device fleet information and at least one of the environmental information and the operational information exceeding a threshold value a replacement print material supply for the imaging device. For example, the computing device 302 can select a first print material supply being a first size or a second print material supply being a second size, where the first size print material supply is physically smaller relative to the second size print material supply.

At 454, the method 444 includes causing, by the computing device, the selected replacement print material supply to be shipped to the location. For example, the print material supply can be shipped from a fulfilment center to the location including the imaging device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processing resource; and
a memory resource storing non-transitory machine-readable instructions to cause the processing resource to:
determine, based on a geographic identifier of an imaging device, environmental information for a location associated with the imaging device;
determine operational information for the imaging device; and
select, based on at least one of the environmental information and the operational information, a print material supply for the imaging device.

2. The computing device of claim 1, wherein the processing resource is to cause the selected print material supply to be shipped to the location.

3. The computing device of claim 1, wherein the selected print material supply is a first print material supply of a plurality of print material supplies, wherein the plurality of print material supplies further includes a second print material supply.

4. The computing device of claim 3, wherein:
the first print material supply is smaller than the second print material supply; and
the processing resource is to select the first print material supply in response to at least one of the environmental information exceeding a threshold value and the operational information exceeding a different threshold value.

5. The computing device of claim 3, wherein:
the first print material supply is larger than the second print material supply; and
the processing resource is to select the first print material supply in response to at least one of the environmental information not exceeding a threshold value and the operational information not exceeding a different threshold value.

6. The computing device of claim 1, wherein the environmental information for the location includes at least one of:
historical environmental information for the location; and
future environmental information for the location.

7. The computing device of claim 1, wherein the geographic identifier includes a physical location address corresponding to the imaging device.

8. The computing device of claim 1, wherein the geographic identifier includes a geographic location of a mobile device associated with the imaging device.

9. A non-transitory machine-readable storage medium including instructions that when executed cause a processing resource to:
determine, based on a geographic identifier of an imaging device, environmental information for a location associated with the imaging device;
determine operational information for the imaging device;
select, based on at least one of the environmental information and the operational information exceeding a threshold value, a print material supply for the imaging device; and
cause the selected print material supply to be shipped to the location.

10. The non-transitory storage medium of claim 9, wherein the instructions to determine the operational information include instructions to determine usage information for the imaging device.

11. The non-transitory storage medium of claim 9, wherein the instructions to determine the operational information include instructions to determine error information of the imaging device.

12. A method, comprising:
transmitting, by an imaging device, a fulfilment signal to a computing device in response to an amount of print material in a print material supply being less than a threshold amount;
determining, by the computing device based on a geographic identifier of the imaging device, environmental information for a location associated with the imaging device in response to receiving the fulfilment signal;
determining, by the computing device, operational information for the imaging device;
selecting, by the computing device based on imaging device fleet information and at least one of the environmental information and the operational information exceeding a threshold value a replacement print material supply for the imaging device: and
causing, by the computing device, the selected replacement print material supply to be shipped to the location.

13. The method of claim 12, wherein the method includes determining the imaging device fleet information in response to receiving imaging device fleet data from a plurality of imaging devices, wherein the imaging device fleet data includes operational information for the plurality of imaging devices.

14. The method of claim 13, wherein the method includes determining, by the computing device, a risk area by correlating the imaging device fleet data to:
locations of the plurality of imaging devices;
a time period; and
environmental information for the locations of the plurality of imaging devices and the time period.

15. The method of claim 14, wherein the method includes:
determining, by the computing device, whether the imaging device is included in the risk area; and
selecting, by the computing device, the replacement print material supply for the imaging device, wherein:
the replacement print material supply is a first replacement print material supply in response to the imaging device being included in the risk area; and
the replacement print material supply is a second replacement print material supply in response to the imaging device being outside of the risk area.
